(19) United States
(12) Patent Application Publication
(10) Pub. No.: US 2019/0103766 A1
(43) Pub. Date: Apr. 4, 2019

(54) MULTIPLE INPUT SINGLE INDUCTOR MULTIPLE OUTPUT (MISIMO) POWER CONVERSION FOR POWER MANAGEMENT CIRCUITS

(71) Applicant: QUALCOMM Incorporated, San Diego, CA (US)

(72) Inventors: William Henry VON NOVAK, III, San Diego, CA (US); Chunlei SHI, San Diego, CA (US)

(21) Appl. No.: 16/122,747

(22) Filed: Sep. 5, 2018

Related U.S. Application Data
(60) Provisional application No. 62/567,650, filed on Oct. 3, 2017.

(51) Int. Cl. H02J 50/12; H02J 7/02; H02J 7/04; H02M 7/06

(52) U.S. Cl. CPC H02J 50/12; H02M 7/06; H02J 7/04; H02J 7/025

(57) ABSTRACT

Certain aspects of the present disclosure relate to methods and apparatus for Multiple Input Single Inductor Multiple Output (MISIMO) power conversion for power management circuits. Certain aspects provide a method for controlling a power conversion circuit. The method includes selectively opening and closing one of a first switch, second, and third switch to cause a terminal coupled to an output of the third switch to carry a signal at a first voltage based on one or more parameters associated with a first voltage source and one or more parameters associated with a second voltage source. The method further includes selectively opening and closing one of the first switch and the second switch and a fourth switch to cause a terminal coupled to an output of the fourth switch to carry a signal at a second voltage based on each of the one or more parameters.

### CROSS-REFERENCE TO RELATED APPLICATIONS

This application claims the benefit of U.S. Provisional Patent No. 62/567,650, filed Oct. 3, 2017. The content of the provisional application is hereby incorporated by reference in its entirety.

### TECHNICAL FIELD

The present disclosure relates generally to power management, and in particular to MISIMO power conversion for power management circuits (e.g., power management integrated circuits (PMICs)).

### BACKGROUND

Electronic devices (e.g., wearables, Internet of Things (IOT) devices, medical implants, cell phones, smartphones, computing devices, tablets, etc.) may include several components, such as processor cores, peripheral rings, memory, backlights, universal serial bus (USB) components, etc. These components in an electronic device may operate at different voltages. Accordingly, many such electronic devices include a PMIC that generates multiple outputs at different voltages to supply power to the components that operate at the different voltages in the electronic device.

In some cases, the electronics devices may be powered by wireless power transfer systems that can be used to charge and/or power electronic devices without physical, electrical connections. Such wireless power transfer systems can reduce the number of components required for operation of the electronic devices and simplify the use of the electronic device. Further, such wireless power transfer systems can be used to power electronic devices in areas that are not necessarily accessible to provide wired power transfer.

Further, the use of wireless power may eliminate the need for cords/cables to be attached to the electronic devices, which may be inconvenient and aesthetically displeasing.

Different electronic devices may have different shapes, sizes, and power requirements. There is flexibility in having different sizes and shapes in the components (e.g., magnetic coil, charging plate, etc.) that make up a wireless power transmitter and/or a wireless power receiver in terms of industrial design and support for a wide range of devices.

### SUMMARY

Certain aspects of the present disclosure provide a power conversion circuit. The power conversion circuit includes an inductor comprising an input terminal and an output terminal. The power conversion circuit further includes a first plurality of switches including a first switch having an input coupled to a first voltage source and an output coupled to the input terminal of the inductor; and a second switch having an input coupled to a second voltage source and an output coupled to the input terminal of the inductor. The power conversion circuit further includes a second plurality of switches including a third switch having an input coupled to the output terminal of the inductor and an output coupled to a terminal configured to carry a signal at a first voltage; and a fourth switch having an input coupled to the output terminal of the inductor and an output coupled to a terminal configured to carry a signal at a second voltage.

In certain aspects, the power conversion circuit further includes a controller coupled to the first plurality of switches and the second plurality of switches. The controller is configured to selectively open and close one of the first switch and the second switch and the third switch to cause the terminal coupled to the output of the third switch to carry the signal at the first voltage based on one or more parameters associated with the first voltage source and one or more parameters associated with the second voltage source. The controller is further configured to selectively open and close one of the first switch and the second switch and the fourth switch to cause the terminal coupled to the output of the fourth switch to carry the signal at the second voltage based on one or more parameters associated with the first voltage source and one or more parameters associated with the second voltage source.

Certain aspects of the present disclosure provide a controller configured to control a power conversion circuit. The controller includes at least a first conductor configured to couple to a first plurality of switches. The first plurality of switches includes a first switch having an input coupled to a first voltage source and an output coupled to an input terminal of an inductor; and a second switch having an input coupled to a second voltage source and an output coupled to the input terminal of the inductor. The controller further includes at least a second conductor configured to couple to a second plurality of switches. The second plurality of switches includes a third switch having an input coupled to an output terminal of the inductor and an output coupled to a terminal configured to carry a signal at a first voltage; and a fourth switch having an input coupled to the output terminal of the inductor and an output coupled to a terminal configured to carry a signal at a second voltage. The controller further includes circuitry configured to selectively open and close one of the first switch and the second switch and the third switch to cause the terminal coupled to the output of the third switch to carry the signal at the first voltage based on one or more parameters associated with the first voltage source and one or more parameters associated with the second voltage source; and selectively open and close one of the first switch and the second switch and the fourth switch to cause the terminal coupled to the output of the fourth switch to carry the signal at the second voltage based on one or more parameters associated with the first voltage source and one or more parameters associated with the second voltage source.

Certain aspects of the present disclosure provide a controller configured to control a power conversion circuit. The controller includes means for coupling to a first plurality of switches. The first plurality of switches includes a first switch having an input coupled to a first voltage source and an output coupled to an input terminal of an inductor; and a second switch having an input coupled to a second voltage source and an output coupled to the input terminal of the inductor. The controller further includes means for coupling to a second plurality of switches. The second plurality of switches includes a third switch having an input coupled to an output terminal of the inductor and an output coupled to a terminal configured to carry a signal at a first voltage; and a fourth switch having an input coupled to the output terminal of the inductor and an output coupled to a terminal configured to carry a signal at a second voltage. The controller further includes means for selectively open and close one of the first switch and the second switch and the third switch to cause the terminal coupled to the output of the third switch to carry the signal at the first voltage based on one or more parameters associated with the first voltage source and one or more parameters associated with the second voltage source; and means for selectively open and close one of the first switch and the second switch and the fourth switch to cause the terminal coupled to the output of the fourth switch to carry the signal at the second voltage based on one or more parameters associated with the first voltage source and one or more parameters associated with the second voltage source.

Certain aspects of the present disclosure provide a method for controlling a power conversion circuit a first plurality of switches and a second plurality of switches, the first plurality of switches comprising a first switch having an input coupled to a first voltage source and an output coupled to an input terminal of an inductor and a second switch having an input coupled to a second voltage source and an output coupled to the input terminal of the inductor, the second plurality of switches comprising a third switch having an input coupled to an output terminal of the inductor and an output coupled to a terminal configured to carry a signal at a first voltage and a fourth switch having an input coupled to the output terminal of the inductor and an output coupled to a terminal configured to carry a signal at a second voltage. The method includes selectively opening and closing one of the first switch and the second switch and the third switch to cause the terminal coupled to the output of the third switch to carry the signal at the first voltage based on one or more parameters associated with the first voltage source and one or more parameters associated with the second voltage source. The method further includes selectively opening and closing one of the first switch and the second switch and the fourth switch to cause the terminal coupled to the output of the fourth switch to carry the signal at the second voltage based on one or more parameters associated with the first voltage source and one or more parameters associated with the second voltage source.

The following detailed description and accompanying drawings provide a better understanding of the nature and advantages of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. In the accompanying drawings:

FIG. 1 is a functional block diagram of a wireless power transfer system in accordance with an illustrative aspect.

FIG. 2 is a functional block diagram of a wireless power transfer system in accordance with an illustrative aspect.

FIG. 3 is a schematic diagram of a portion of transmit circuitry or receive circuitry of FIG. 2 including a power transmitting or receiving element in accordance with an illustrative aspect.

FIG. 4 is a circuit diagram of an example of a SIMO converter, in accordance with certain aspects of the present disclosure.

FIG. 5 is a block diagram of an example of power conversion circuit, in accordance with certain aspects of the present disclosure.

FIG. 6 is a block diagram of an example of power conversion circuit, in accordance with certain aspects of the present disclosure.

FIG. 6A is a schematic diagram of an example of MISIMO converter of a PMIC of FIG. 6, in accordance with certain aspects of the present disclosure.

FIG. 7 is an example of an output of a decision matrix for a PMIC of FIG. 6 for selecting a voltage source, in accordance with certain aspects of the present disclosure.

FIG. 8 is a flowchart of example operations for performing power conversion by a MISIMO, in accordance with certain aspects of the present disclosure.

### DETAILED DESCRIPTION

Drawing elements that are common among the following figures may be identified using the same reference numerals.

Wireless power transfer may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field or an electromagnetic field) may be received, captured by, or coupled by a “power receiving element” to achieve power transfer.

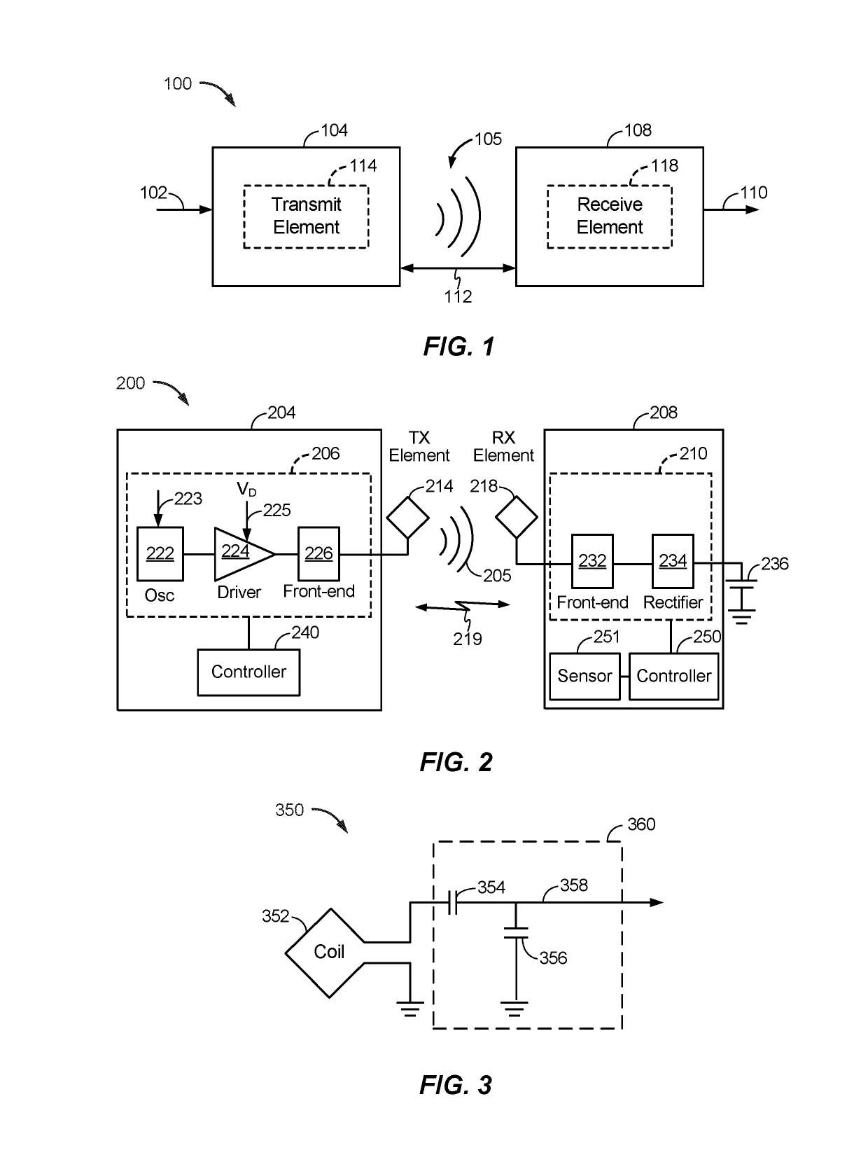

FIG. 1 is a functional block diagram of a wireless power transfer system 100, in accordance with an illustrative aspect. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) coupled to the output power 110. The transmitter 104 and the receiver 108 may be separated by a distance 112. The transmitter 104 may include a power transmitting element 114 for transmitting/coupling energy to the receiver 108. The receiver 108 may include a power receiving element 118 for receiving or capturing/coupling energy transmitted from the transmitter 104.

In one illustrative aspect, the transmitter 104 and the receiver 108 may be configured according to a mutual resonant relationship. When the resonant frequency of the receiver 108 and the resonant frequency of the transmitter 104 are substantially the same or very close, transmission losses between the transmitter 104 and the receiver 108 are reduced. As such, wireless power transfer may be provided over larger distances. Resonant inductive coupling techniques may thus allow for improved efficiency and power transfer over various distances and with a variety of inductive power transmitting and receiving element configurations.

In certain aspects, the wireless field 105 may correspond to the “near-field” of the transmitter 104. The near-field may correspond to a region in which there are strong reactive fields resulting from the currents and charges in the power transmitting element 114 that minimally radiate power away from the power transmitting element 114. The near-field may correspond to a region that is within about one wavelength (or a fraction thereof) of the power transmitting element 114. Conversely, the far field may correspond to a region that is greater than about one wavelength of the power transmitting element 114.

In certain aspects, efficient energy transfer may occur by coupling a large portion of the energy in the wireless field 105 to the power receiving element 118 rather than propagating most of the energy in an electromagnetic wave to the far field.

In certain implementations, the transmitter 104 may output a time varying magnetic (or electromagnetic) field with a frequency corresponding to the resonant frequency of the power transmitting element 114. When the receiver 108 is within the wireless field 105, the time varying magnetic (or electromagnetic) field may induce a current in the power receiving element 118. As described above, if the power receiving element 118 is configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge or to power a load.

FIG. 2 is a functional block diagram of a wireless power transfer system 200, in accordance with another illustrative aspect. The system 200 may include a transmitter 204 and a receiver 208. The transmitter 204 (also referred to herein as power transfer unit, PTU) may include transmit circuitry 206 that may include an oscillator 222, a driver circuit 224, and a front-end circuit 226. The oscillator 222 may be configured to generate an oscillator signal (e.g., an oscillating signal) at a desired frequency (e.g., fundamental frequency) that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output as a driving signal output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or otherwise powering a load (e.g., an implant without a battery 236).

The transmitter 204 may further include a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by it. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) may include receive circuitry 210 that may include a front-end circuit 232 and a rectifier circuit 234. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236 or power a load, as shown in FIG. 2. The receiver 208 and the transmitter 204 may additionally communicate on a separate communication channel 219 (e.g., Bluetooth, Zigbee, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236 or powering a load. In certain aspects, the transmitter 204 may be configured to generate a predominantly non-radiative field with a direct field coupling coefficient (k) for providing energy transfer. Receiver 208 may directly couple to the wireless field 205 and may generate an output power for storing or consumption by a battery (or load) 236 coupled to the output or receive circuitry 210.

The receiver 208 may further include a controller 250 configured similarly to the transmit controller 240 as described above for managing one or more aspects of the wireless power receiver 208. In some aspects, the controller 250 is configure to control functionality (e.g., switches) of a MISIMO power converter based on operating parameters of the receiver 208. For example, the controller 250, in some aspects, is coupled to a sensor 251 and/or additional sensors. The sensor 251 may be a voltage and/or current sensing circuit configured to indicate electrical properties of the receiver 208 to the controller 250. For example, in some aspects the sensor 251 measures electrical properties (e.g., input voltage, output voltage, output current, etc.) at various components of the receiver 208 and adjusts how an output voltage is supplied to components of an electronic device. In some aspects, the controller 250 may comprise an integrated circuit, power management integrated circuit (PMIC), processor, etc.

The receiver 208 may further include a memory (not shown) configured to store data, for example, such as instructions, algorithms, tables, etc., for causing the controller 250 to perform particular functions, such as those related to management of wireless power transfer.

As discussed above, transmitter 204 and receiver 208 may be separated by a distance and may be configured according to a mutual resonant relationship to minimize transmission losses between the transmitter 204 and the receiver 208.

FIG. 3 is a schematic diagram of a portion of the transmit circuitry 206 coupled to transmitting element 214 or the receive circuitry 210 coupled to receiving element 218 of FIG. 2, in accordance with illustrative aspects. As illustrated in FIG. 3, transmit or receive circuitry 350 may include a power transmitting or receiving element 352 (e.g., corresponding to transmitting element 214 or receiving element 218) and a tuning circuit 360 (e.g., corresponding to front-end 226 or front-end 232). The power transmitting or receiving element 352 may also be referred to or be configured as an antenna or a “loop” antenna. The term “antenna” generally refers to a component that may wirelessly output or receive energy for coupling to another antenna. The power transmitting or receiving element 352 may also be referred to herein or be configured as a “magnetic” antenna, or an induction coil, a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown in this figure). In some aspects, the term resonator, as used herein may refer to the entire resonant circuit including an inductor in combination with the capacitance of one or more capacitors of the resonant circuit.

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit and/or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. In some aspects, the tuning circuit in the front-end circuit 226 may have the same design (e.g., 360) as the tuning circuit in front-end circuit 232. In other aspects, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

Although aspects disclosed herein may be used in systems related to resonant wireless power transfer, persons of ordinary skill will appreciate that aspects disclosed herein may be used in other non-resonant implementations for wireless power transfer, and in wired power applications. In particular, some aspects herein relate to a power management circuit (e.g., PMIC) that can be used to generate multiple outputs with different voltages to apply to different loads (e.g., to charge a battery, to power different components of an electronic device, etc.) based on input voltages from a power supply (e.g., a wireless power receiver). The power supply may include multiple voltage sources that supply power at different voltage levels.

Many electronic devices may have small electronic designs. Production techniques such as very-large-scale-integration (VLSI), 3D chip stacking, smaller geometries, etc., allow integrated circuits (ICs) in such electronic devices to be very small. However, other components (e.g., inductors) in an electronic device may be relatively larger. Accordingly, to maintain a smaller electronic device, it may be beneficial to reduce the number and/or size of such other components in an electronic device.

PMICs often generate multiple outputs at different voltage levels to supply voltage to different components of an electronic device. In some aspects, generating a number of different voltages may utilize a large number of components external to the PMIC.

In certain aspects, a single inductor multiple output (SIMO) converter may be used to help reduce the number of components utilized in an electronic device to generate a number of different voltages from a power supply. For example, traditionally a separate buck converter and inductor may have been used to generate each of the multiple outputs from a PMIC. A SIMO converter, however, allows a single inductor to be used (e.g., shared using switches) for each of the multiple outputs from the PMIC.

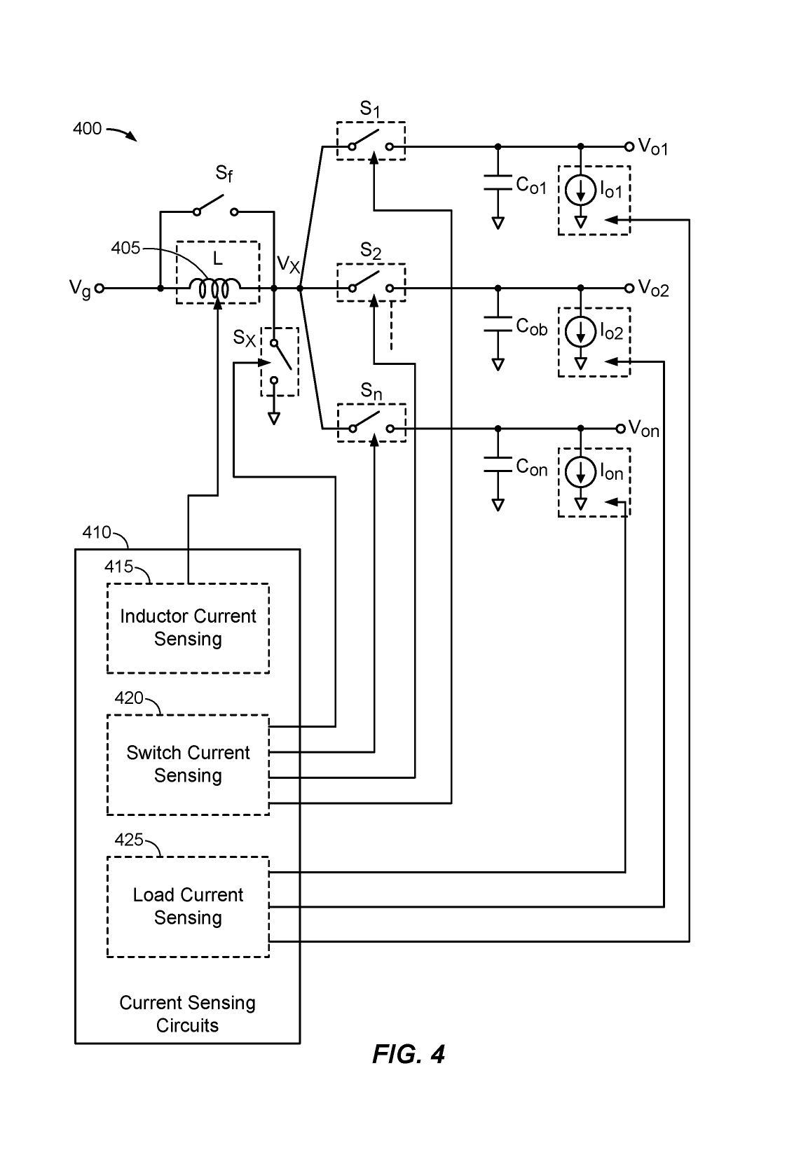

FIG. 4 is a circuit diagram of an example of a SIMO converter 400, in accordance with certain aspects of the present disclosure. As shown, the SIMO converter 400 includes a single inductor 405. Further, the SIMO converter 400 receives a single signal with a voltage V_{g} as input to the SIMO converter 400, and generates multiple output signals with voltages Vₒ₁, Vₒ₂, . . . , Vₒₙ, etc. as output from the SIMO converter 400. The SIMO converter 400 further includes current sensing circuits 410, including an inductor current sensing circuit 415, a switch current sensing circuit 420, and a load current sensing circuit 425. The current sensing circuits 410, based on the sensed current, may be configured to control switches of the SIMO converter 400 (e.g., S_{f}, S₁, S₂, . . . Sₙ), to selectively open and close the switches so as to generate the desired output voltages at the outputs of the SIMO converter 400 utilizing the single inductor 405. For example, the duration that a switch associated with an output is open versus closed (e.g., S₁ is associated with Vₒ₁) may determine the output voltage for the output. By alternating opening and closing S₁, S₂, . . . Sₙ and Sₓ, multiple outputs can be provided at multiple different voltages.

For example, when S₁ is closed (and the remaining switches shown are open), the output of inductor 405 is coupled to the line carrying Vₒ₁. S₁ may be opened and closed according to a duty cycle such that the signal on the line carrying Vₒ₁ has a voltage of Vₒ₁. Similarly, S₂-Sₙ may be opened and closed according to respective duty cycles such that the signals on the lines carrying Vₒ₁-Vₒₙ have voltages of Vₒ₁-Vₒₙ respectively. In certain aspects, S_{f} may be closed so that the single signal with a voltage V_{g} bypasses inductor 405, such as to directly apply the voltage V_{g} to one of the lines carrying Vₒ₁-Vₒₙ. In certain aspects, Sₓ is closed to couple the output of inductor 405 to ground. The switches S_{f} and Sₓ can be controlled to periodically interrupt current flowing into inductor 405 (e.g., switch S_{f}) and/or periodically shorts the inductor 405's input or output to ground (e.g., switch Sₓ). This can either increase or decrease a voltage.

Such a SIMO converter 400 may be useful where the input to the SIMO converter 400 is a single signal with a relatively stable voltage level. However, some power supplies may supply power with a varying voltage level. For example, in certain aspects, the induced voltage at a wireless power receiver (e.g., receiver 208) due to a wireless field (e.g., wireless field 205 generated by a wireless power transmitter (e.g., transmitter 204) may vary. For example, the coupling between the wireless power receiver 208 and the wireless power transmitter 204 may change due to distance or material between the receiver 208 and the transmitter 204, leading to variations in induced voltage at the receiver 208. Due to such varied coupling, the rectifier 234 may be configured to generate a power supply signal within a large voltage range (e.g., 5-20 V). Due to such a large voltage range, a separate DC/DC converter may (e.g., buck/boost converter) including a large inductor may need to be implemented between the rectifier 234 and a PMIC to buck or reduce the output voltage of the rectifier 234 to usable voltages. The use of an additional large inductor in addition to the inductor 405 in SIMO converter 400 may be undesirable. However, the inductor 405 may be too small to support the large voltage output range from rectifier 234.

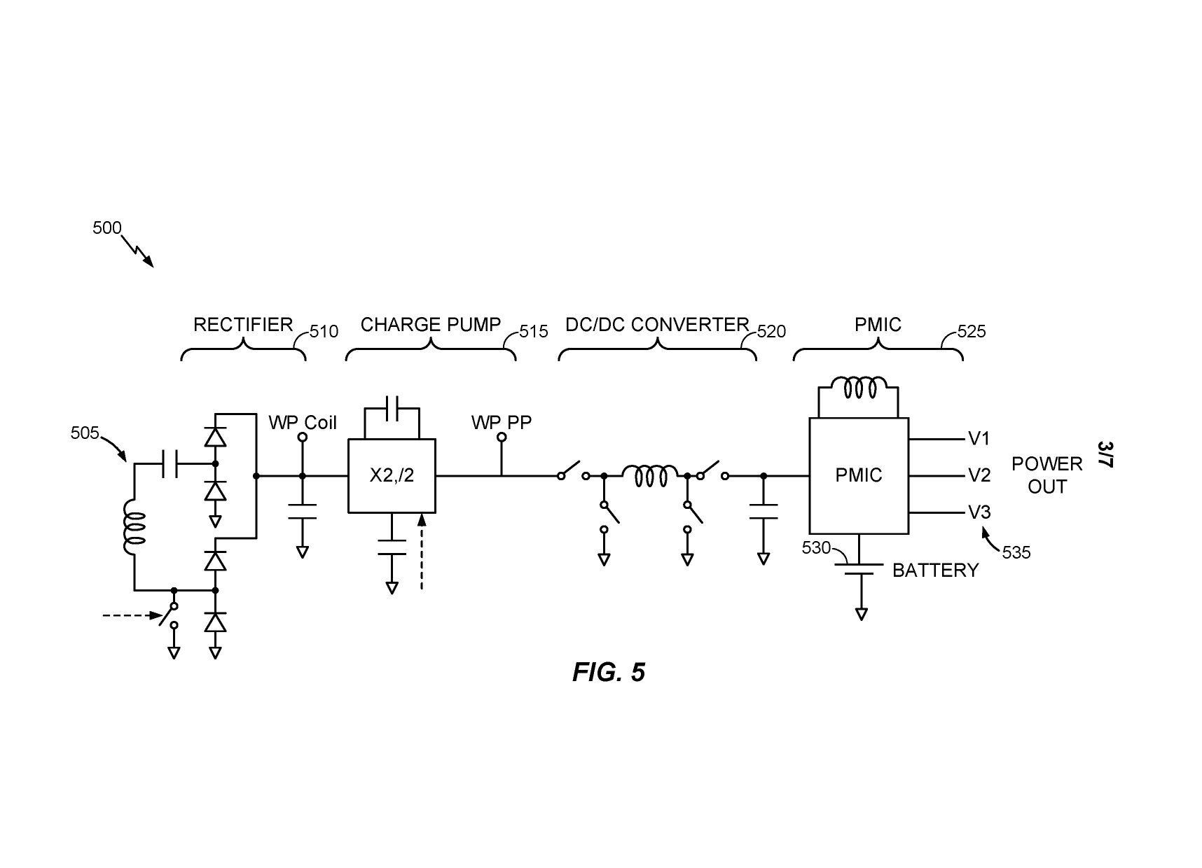

FIG. 5 is a block diagram of an example of power conversion circuit 500, in accordance with certain aspects of the present disclosure.

As shown, power conversion circuit 500 includes a wireless power receiver 505 (e.g., receiver 208) including a rectifier 510 (e.g., rectifier 234). It should be noted that though a certain rectifier comprising diodes is shown, similarly another rectifier (e.g., using switches) or other rectifier design may be used. The rectifier 510, in some aspects, may include a switch that changes a mode of rectifier 510 between a doubler (e.g., including two diodes/field-effect transistors (FETS)) or a full wave bridge (e.g., including four diodes/FETS) rectifier. The mode of rectifier 510 may be selected to change the gain (e.g., 1× or 2× gain) in the AC to DC conversion performed by the rectifier 510. The rectifier 510 may accordingly be a voltage source (e.g., referred to as a wireless power (WP) coil voltage source) and generate a supply voltage V_{rect}. The losses at the rectifier 510 during power conversion may be primarily forward voltage in the case where rectifier 510 is implemented with diodes (e.g., 2× worse for the full wave bridge as compared to the doubler) and primarily tare losses due to switching gate capacitance in the case where rectifier 510 is implemented with synchronous FETs (e.g., worse for the full wave bridge as compared to the doubler since more devices are being switched.)

The output of the rectifier 510 may be coupled to an input of a charge pump 515. The charge pump 515 may be configured to perform DC-DC conversion and change the DC output V_{rect} of rectifier 510, such as by dividing or multiplying the output voltage V_{rect} by 2 to generate an output voltage V_{CP}. The charge pump 515 may accordingly be a voltage source (e.g., referred to as a WP post pre-regulation (PP) voltage source (e.g., the rectifier 510 and charge pump 515 may be examples of pre-regulators of power conversion circuit 500 for regulating the voltage output of wireless power receiver 505)) and generate a supply voltage V_{CP}. In certain aspects, the losses at charge pump 515 may be low due to switched capacitor technology being used to implement charge pump 515. In certain aspects, since no loss elements other than gate capacitance charge switching and FET conduction losses are present, this can be very efficient (e.g., on the order of 99%).

The output of the charge pump 515 may be coupled to an input of a DC-DC converter 520 (e.g., buck converter, boost converter, buck/boost converter, etc.) that includes an inductor. The DC-DC converter 520 may be an example of a regulator of power conversion circuit 500. The DC-DC converter 520 may be configured to change the DC output of V_{c}p of charge pump 515 to a voltage suitable for charging a battery 530 (e.g., 4.2V). For example, DC-DC converter 520 may be a buck converter which is a continuously variable converter that periodically interrupts current flowing into an inductor. The inductor continues to transfer a decaying amount of current to the output of DC-DC converter 520 due to its characteristic inductance. This interruption is controlled (e.g., by varying on-time/off-time), such as by controller 250, to generate a specific output voltage (e.g., 4.2V). Such a buck converter has fixed losses (e.g., gate charge), losses that depend on current (e.g., FET resistance), but also losses that depend on the ratio of input to output voltage (e.g., due to Miller capacitance, peak inductor current, required inductor sizing, etc.). In another example, DC-DC converter 520 may be a buck/boost converter which is a continuously variable converter that periodically interrupts current flowing into an inductor and/or periodically shorts the inductor's input or output to ground. This can either increase or decrease a voltage. A buck/boost converter may have similar losses to a buck converter.

The output of DC-DC converter 520 may be input into a PMIC 525. The PMIC 525 may include a SIMO converter (e.g., SIMO converter 400) to generate the multiple output voltages of the PMIC 525 at output terminals 535 at different voltages (e.g., V₁, V₂, and V₃).

In order to reduce the size of power conversion circuits (e.g., power conversion circuit 500) certain aspects herein relate to using a multiple input single inductor multiple output (MISIMO) converter to perform power conversion. In certain aspects, such a power conversion circuit may be used with a power supply that has multiple voltage sources at different voltage levels (e.g., a wireless power receiver, such as receiver 208). Such a power conversion circuit may use the inductor of the MISIMO converter, and not a separate DC-DC converter including an inductor like power conversion circuit 500. In certain aspects, the power conversion circuit includes one or more pre-regulators configured to bring a maximum voltage of a wireless power receiver to a lower level, and a MISIMO converter that can use as input different voltage sources (e.g., from the rectifier, from the battery, from the charge pump, from a pre-regulator component, etc.) of the power conversion circuit.

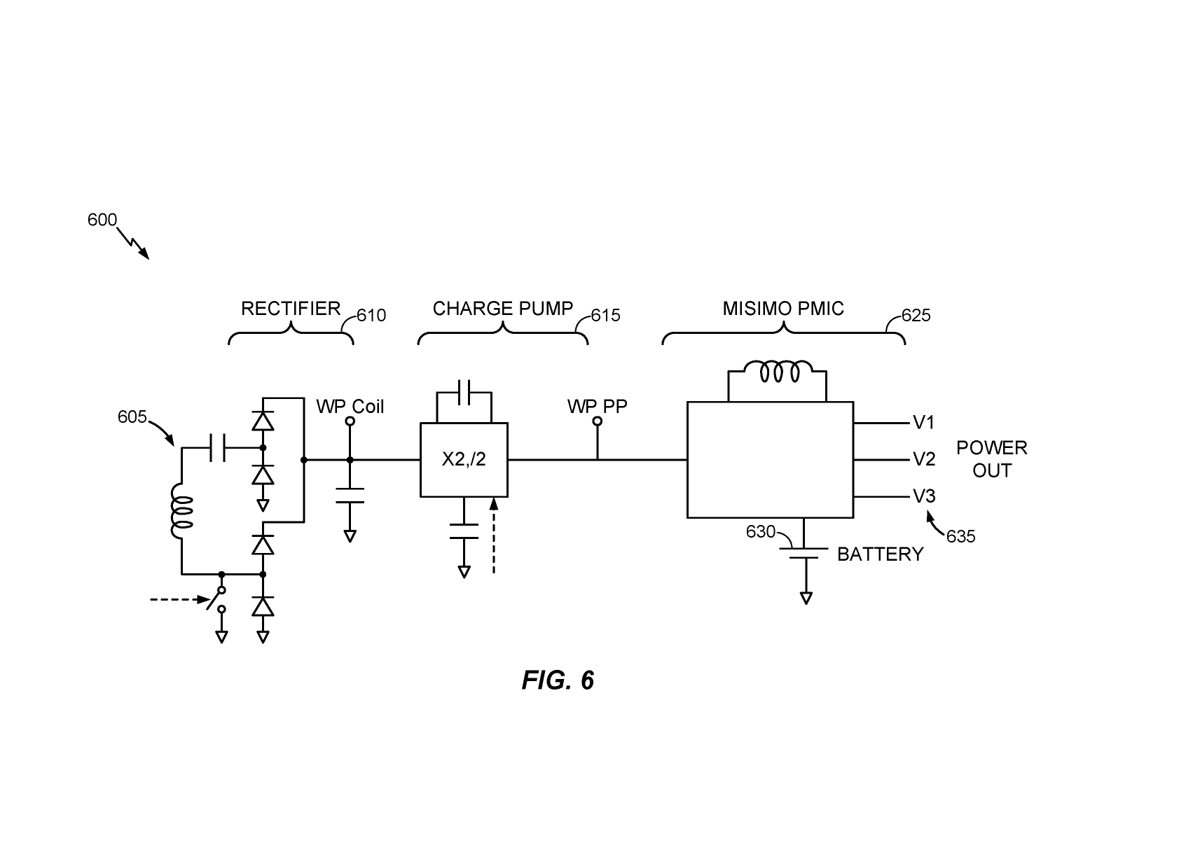

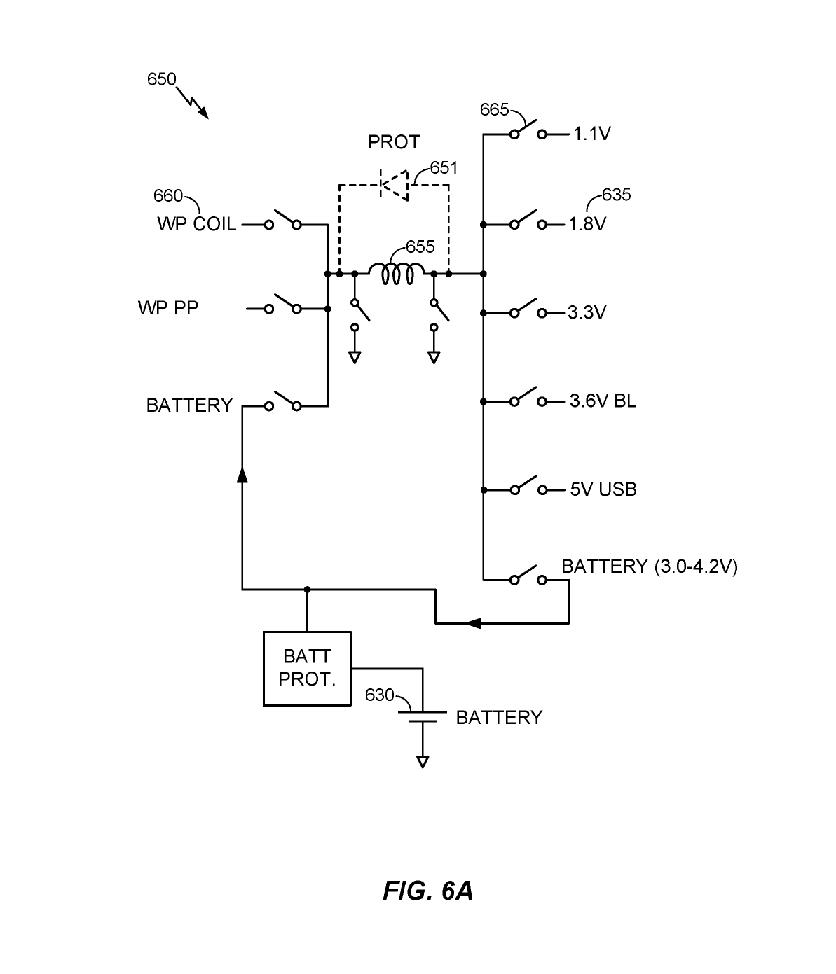

FIG. 6 is a block diagram of an example of power conversion circuit 600, in accordance with certain aspects of the present disclosure.

The power conversion circuit 600 includes a wireless power receiver 605 (e.g., receiver 208) including a rectifier 610 (e.g., similar to rectifier 510), a charge pump 615 (e.g., similar to charge pump 515), and a PMIC 625. The PMIC 625 may include multiple output terminals 635 including a coupling to battery 630. The PMIC 625 may be similar to PMIC 525, but instead of a SIMO includes a MISIMO. The power conversion circuit 600, in certain aspects, does not include an additional DC-DC converter that includes an inductor like DC-DC converter 525 other than the inductor of the MISIMO in PMIC 625. Also note that in certain aspects, the charge pump 615 may also be removed, such as due to the enhanced regulation capabilities of a MISIMO converter.

FIG. 6A is a schematic diagram of an example of MISIMO converter 650 of PMIC 625, in accordance with certain aspects of the present disclosure. The MISIMO converter 650 includes an inductor 655. Optionally, a protection circuit 651 is coupled across the inductor 655. The protection circuit 651 may provide over voltage protection (OVP) or recirculation of flyback currents to the inductor 655. For example, if the opening and closing of switches of MISIMO converter 650 should fail, inductor 655 may be unconnected with associated flyback voltages. The protection circuit 651 may protect against such unconnected inductor flyback voltages. In certain aspects, protection circuit 651 may comprise a diode (e.g., a Schottky or Zener diode) that goes across the inductor 655 or from a junction of the inductor 655 to ground and limits voltages to the breakdown voltage of the diode in the direction towards the loads, and to the forward voltage of the diode in the direction towards the sources. In certain aspects, where the inductor 655 is operated as a buck converter, a single diode may be sufficient. In certain aspects, where the inductor 655 is operated as a buck/boost converter back-to-back Zener diodes may be used (e.g., to allow voltage gain across the inductor 655). In certain aspects the protection circuit 651 includes a diode connected to the highest potential in a system including the MISIMO converter 650.

An input terminal of the inductor 655 is coupled to a plurality of switches, referred to as input switches 660. An output terminal of the inductor 655 is coupled to a plurality of switches, referred to as output switches 665. The output of each of the output switches 655 may further be coupled to a capacitor (not shown) and each output may correspond to an output terminal 635. The PMIC 625, similar to SIMO converter 400, may be configured to control output switches 665 to selectively open and close the output switches 665 so as to generate the desired output voltages at the outputs of the MISIMO converter 650 utilizing the single inductor 655. Further, PMIC 625 may be configured to selectively close one of the input switches 660 (e.g., and keep open the other input switches 660) so as to provide voltage from a voltage source coupled to the closed input switch 660 to inductor 655 to generate the desired output voltage. In certain aspects, one input switch 660 may be coupled to an output of rectifier 610 (e.g., referred to as a wireless power (WP) coil voltage source). In certain aspects, one input switch 660 may be coupled to an output of charge pump 615 (e.g., referred to as a WP post pre-regulator (PP) voltage source). In certain aspects, one input switch 660 may be coupled to battery 630 configured to be charged by PMIC 625. It should be noted that other voltage sources of power conversion circuit 600 (e.g., pre-regulators) may be additionally or alternatively coupled to an input switch 660.

In certain aspects, the input switches 660 and the output switches 665 are controlled by a controller (e.g., PMIC 625) implementing a control algorithm configured to enhance efficiency of the power conversion of power conversion circuit 600. The controller may couple to input switches 660 and output switches 665 via conductors. As discussed, each output terminal 635 may be configured to carry a signal with a particular voltage. In certain aspects, PMIC 625 may be configured to utilize the voltage source with the lowest voltage that is higher than that of the voltage to be provided on the output terminal to generate the voltage for the output terminal. For example, if three voltage sources provide 3, 6, and 9 volts, respectively, and the output terminal is configured to carry 5 volts, the 6 volt voltage source would be used to generate the voltage for the output terminal. Accordingly, the input switch 660 associated with the 6 volt voltage source may be opened and closed, and the output switch 665 associated with the terminal may be closed to provide the desired voltage of 5 V. It should be noted that in certain such aspects, the switch to ground before the inductor 655 may be opened and closed in complement to an input switch 660 when bucking voltage, such as an input switch 660 associated with the 6 volt source. In certain aspects, by using the lowest voltage that is higher than that of the voltage to be provided on the output terminal the inductor 655 can act as only a buck converter (not a boost converter) and further the amount of energy bucked is minimized.

In certain aspects, the input switches 660 and the output switches 665 are controlled by a controller (e.g., PMIC 625) implementing a control algorithm configured to enhance efficiency of the power conversion of power conversion circuit 600. As discussed, each output terminal 635 may be configured to carry a signal with a particular voltage. In certain aspects, PMIC 625 may be configured to utilize the voltage source with the closest voltage to the voltage to be provided on the output terminal to generate the voltage for the output terminal and accordingly inductor 655 may also act as a boost converter. For example, the battery voltage may be less than 5V and used to provide voltage to the output terminal carrying 5V. Accordingly, the input switch 660 associated with the battery voltage source may be closed, and the output switch 665 associated with the terminal may be opened and closed to provide the desired voltage of 5 V. It should be noted that in certain such aspects, the switch to ground after the inductor 655 may be opened and closed in complement to an output switch 665 when boosting voltage, such as an output switch 665 associated with the terminal carrying 5V.

In certain aspects, as discussed, wireless power from wireless power receiver 605 may be a voltage source for MISIMO converter 650. However, the voltage from wireless power receiver 605 (e.g., from rectifier 610 or charge pump 615) may be too high (e.g., 10V) to efficiently buck to the desired voltage at an output terminal 635 (e.g., 1.8V). Accordingly, in certain aspects, the power from wireless power receiver 605 may be bucked by inductor 655 to a first voltage level (e.g., from 10V to 4.2V) and used to charge battery 630 first. The voltage from the battery 630 may then be bucked by the inductor 655 to a second voltage level (e.g., from 4.2V to 1.8V) and output to the output terminal 635. Accordingly, efficiency may be improved and the size of inductor 655 may be reduced.

In certain aspects, many different “classes” of converters (e.g., pre-regulators such as rectifiers, charge pumps, etc. and regulators such as buck converters, buck/boost converters, etc.) may be included in power conversion circuit 600 as discussed and have their own inherent strengths and weaknesses in terms of efficiency (e.g., at different voltages). For example, pre-regulators may perform coarse voltage adjustment at higher efficiency, and regulators may perform fine voltage adjustment at lower efficiency.

In certain aspects, PMIC 625 may be configured to utilize the voltage source associated with the highest efficiency for generating the desired voltage for an output terminal 635 to generate the voltage for the output terminal 635. For example, PMIC 625 may be configured to utilize one or more parameters associated with the voltage sources to determine which voltage source to use to generate the voltage for an output terminal 635. In certain aspects, the one or more parameters include one or more of a desired output voltage for output terminal 635, an input voltage corresponding to the voltage supplied by the voltage source, a desired output current to be supplied to output terminal 635, a voltage source topology associated with the voltage source (e.g., preregulator type, regulator type, etc. such as indicative of conversion efficiency of the voltage source), and/or a previous power conversion efficiency of the voltage source (e.g., conversion efficiency of any previous power conversions performed before being converted by the voltage source, such as a conversion efficiency of rectifier 610 may correspond to the previous power conversion efficiency of charge pump 615). In one example, the PMIC 625 may include an algorithm that selects the voltage source based on the one or more parameters. In another example, PMIC 625 may include a table for selecting the voltage source based on the one or more parameters. For example, PMIC 625 may be configured to evaluate each voltage source and select the voltage source with the highest efficiency based on the one or more parameters.

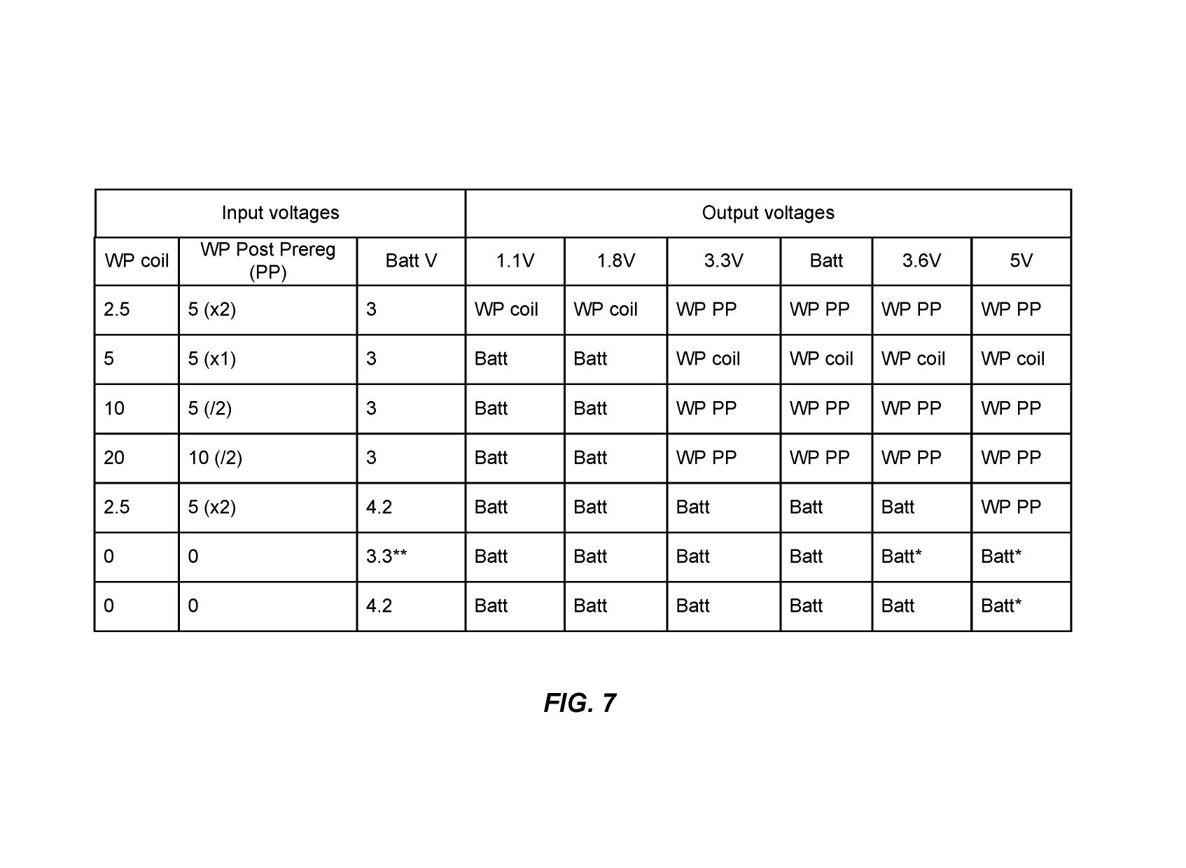

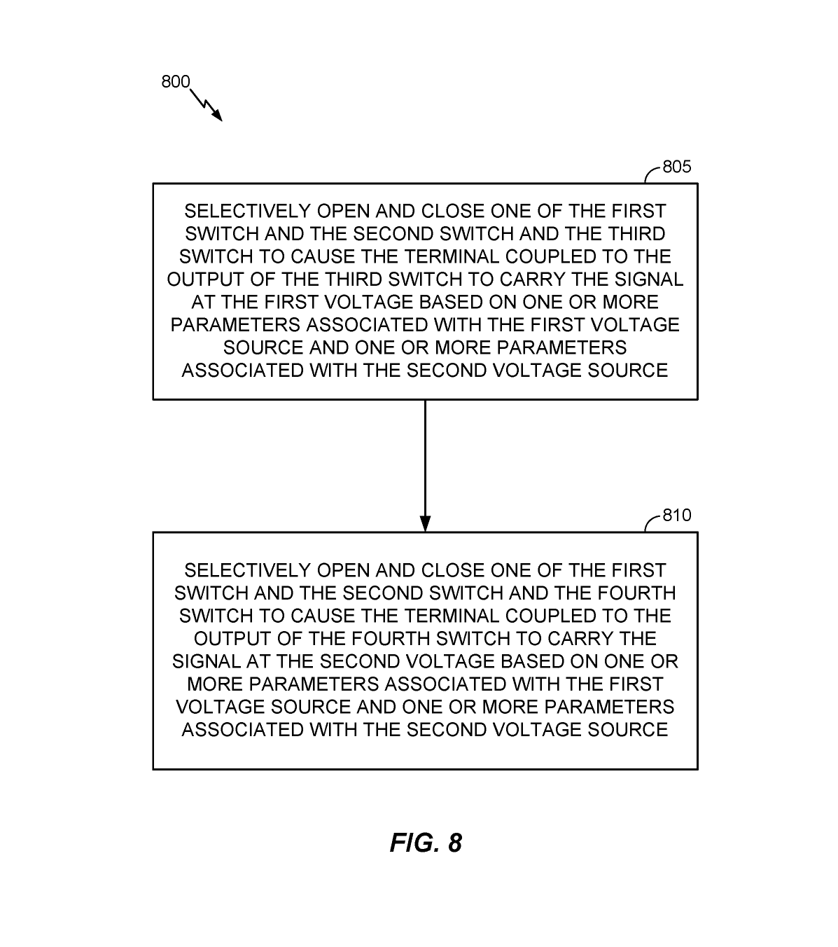

In certain aspects, the PMIC 625 is configured to make the decision rapidly enough to account for changing loads on the PMIC 625, which may change the voltage source to use for efficiency purposes. In certain aspects, the decision may not be made every cycle, but often enough that the system can account for load changes, changes in wireless power voltages, and/or changes in battery voltages. For example, the decision frequency may be faster than the time constants of the voltage sources. FIG. 7 is an example of an output of a decision matrix for PMIC 625 where a voltage source (e.g., wireless power (WP) coil, WP post pre-regulator (PP), or Battery) is selected based on the desired output voltage (e.g., 1.1V, 1.8V, 3.3V, 3.6V, or 5V) and the input voltage provided by the different voltage sources. Values with a “*” indicate boost conversion by the MISIMO may be required. Values with a “**” indicate that the battery protection circuit may trip and disconnect the battery due to undervoltage-lockout at the voltage or a similar voltage. It should be noted that in the table there may be a two-step conversion (e.g., convert to battery voltage, then to desired voltage as discussed) which may incur a double conversion penalty (e.g., 2× worse efficiency), which may be accounted for by the decision algorithm of PMIC 625.

In certain aspects, MISIMO 650 may only operate as a buck converter, and thus a voltage source may be selected so that the input voltage supplied by the voltage source is always higher than the desired output voltage. In certain aspects, MISIMO 650 may operate as a buck/boost converter, and in such cases it may be more efficient to select a voltage source that supplies an input voltage slightly below the desired output voltage (e.g., by a first threshold) and boost the voltage than select a voltage source that supplies an input voltage further above the desired output voltage (e.g., by a second threshold) and buck the voltage. For example, it may be more efficient to boost a 4.2V voltage to 5V than to buck 10V to 5V.

In certain aspects, some devices may be able to tolerate a lower or higher than optimal voltage. For example, a backlight that requires 3.6 volts to drive a white LED may be able to operate at reduced intensity at 3.3 volts, allowing a nearly-dead battery to still operate a device with some degradation. As another example, in some cases a combination of preregulation and standard brightness control (e.g., via pulse width modulation (PWM)) may allow backlighting to bypass the regulator altogether, improving efficiency.

In certain aspects, to provide stability to power conversion circuit 600, the circuit 600 is designed with sufficient impedance margin. For example, in certain aspects the buck converters input in MISIMO 650 may be designed to not drop below the source impedance of the wireless power receiver 605. In certain aspects, this may be implemented by reducing or stopping drawing from the wireless power receiver 605 when its voltage reaches one half of its open circuit voltage.

In certain aspects, buck converters can operate in either continuous or discontinuous mode, which refers to whether there is always current flowing in the inductor 655, or whether it decays to zero. Node switching may be drastically simplified if the current goes to zero, since timing requirements for output switching may then greatly relaxed. However, some such systems may require the increased performance provided by continuous conduction.

FIG. 8 is a flowchart of example operations 800 for performing power conversion by a MISIMO, in accordance with certain aspects of the present disclosure. Operations 800 may be performed by a controller (e.g., PMIC 625) of a power conversion circuit (e.g., power conversion circuit 600), which includes an inductor (e.g., inductor 655) comprising an input terminal and an output terminal. The power conversion circuit further includes a first plurality of switches (e.g., input switches 660) including a first switch having an input coupled to a first voltage source and an output coupled to the input terminal of the inductor; and a second switch having an input coupled to a second voltage source and an output coupled to the input terminal of the inductor. The power conversion circuit further includes a second plurality of switches (e.g., output switches 665) including a third switch having an input coupled to the output terminal of the inductor and an output coupled to a terminal configured to carry a signal at a first voltage; and a fourth switch having an input coupled to the output terminal of the inductor and an output coupled to a terminal configured to carry a signal at a second voltage. The controller may be coupled to the first plurality of switches and the second plurality of switches.

At block 805, the controller selectively opens and closes one of the first switch and the second switch and the third switch to cause the terminal coupled to the output of the third switch to carry the signal at the first voltage based on one or more parameters associated with the first voltage source and one or more parameters associated with the second voltage source. At block 810, the controller selectively opens and closes one of the first switch and the second switch and the fourth switch to cause the terminal coupled to the output of the fourth switch to carry the signal at the second voltage based on one or more parameters associated with the first voltage source and one or more parameters associated with the second voltage source.

The method of FIG. 8 may be used to operate/control any MISIMO and/or suitable PMIC, such as MISIMO 650 in PMIC 625.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC with the processor, the bus interface, the user interface in the case of an access terminal), supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A power conversion circuit comprising:
an inductor comprising an input terminal and an output terminal;
a first plurality of switches comprising:
a first switch having an input coupled to a first voltage source and an output coupled to the input terminal of the inductor; and
a second switch having an input coupled to a second voltage source and an output coupled to the input terminal of the inductor; and
a second plurality of switches comprising:
a third switch having an input coupled to the output terminal of the inductor and an output coupled to a terminal configured to carry a signal at a first voltage; and
a fourth switch having an input coupled to the output terminal of the inductor and an output coupled to a terminal configured to carry a signal at a second voltage.

2. The power conversion circuit of claim 1, further comprising:
a controller coupled to the first plurality of switches and the second plurality of switches, the controller being configured to:
selectively open and close one of the first switch and the second switch and the third switch to cause the terminal coupled to the output of the third switch to carry the signal at the first voltage based on one or more parameters associated with the first voltage source and one or more parameters associated with the second voltage source; and
selectively open and close one of the first switch and the second switch and the fourth switch to cause the terminal coupled to the output of the fourth switch to carry the signal at the second voltage based on one or more parameters associated with the first voltage source and one or more parameters associated with the second voltage source.

3. The power conversion circuit of claim 2, wherein the one or more parameters of the first voltage source and the one or more parameters of the second voltage source comprise an input voltage, an output voltage, and an output current.

4. The power conversion circuit of claim 2, wherein the one or more parameters of the first voltage source and the one or more parameters of the second voltage source comprise a voltage source topology and a previous power conversion efficiency.

5. The power conversion circuit of claim 2, wherein the controller is configured to selectively close one of the first switch and the second switch and the third switch to cause the terminal coupled to the output of the third switch to carry the signal at the first voltage based on which of the first voltage source and the second voltage source generates a voltage closest to the first voltage.

6. The power conversion circuit of claim 1, wherein the first voltage source comprises a battery, and wherein the second voltage source comprises a wireless power receiver.

7. The power conversion circuit of claim 6, wherein the second voltage source comprises at least one of a doubler, full wave bridge, capacitive halver, capacitive doubler, buck converter, boost converter, or buck/boost converter.

8. The power conversion circuit of claim 6, wherein the battery is further coupled to an output of one of the third switch and the fourth switch for charging the battery.

9. The power conversion circuit of claim 1, wherein the first plurality of switches comprises a fifth switch having an input coupled to a third voltage source and an output coupled to the input terminal of the inductor, wherein the first voltage source comprises a battery, wherein the second voltage source comprises a signal between an output of a rectifier of a wireless power receiver and an input of a pre-regulator of the wireless power receiver, and wherein the third voltage source comprises a signal at an output of the pre-regulator of the wireless power receiver.

10. The power conversion circuit of claim 1, further comprising a diode coupled to the inductor configured to provide overvoltage protection for the inductor.

11. The power conversion circuit of claim 1, further comprising:
a third plurality of switches comprising:
an inductor input switch coupled between the inductor and each of the first switch and the second switch and further coupled to ground, the inductor input switch being configured to conduct current from ground when the power conversion circuit is in a buck configuration; and
an inductor output switch coupled between the inductor and each of the third switch and the fourth switch and further coupled to ground, the inductor input switch being configured to conduct current to ground when the power conversion circuit is in a boost configuration.

12. A controller configured to control a power conversion circuit, the controller comprising:
at least a first conductor configured to couple to a first plurality of switches comprising:
a first switch having an input coupled to a first voltage source and an output coupled to an input terminal of an inductor; and
a second switch having an input coupled to a second voltage source and an output coupled to the input terminal of the inductor;
at least a second conductor configured to couple to a second plurality of switches comprising:
a third switch having an input coupled to an output terminal of the inductor and an output coupled to a terminal configured to carry a signal at a first voltage; and
a fourth switch having an input coupled to the output terminal of the inductor and an output coupled to a terminal configured to carry a signal at a second voltage; and
circuitry configured to:
selectively open and close one of the first switch and the second switch and the third switch to cause the terminal coupled to the output of the third switch to carry the signal at the first voltage based on one or more parameters associated with the first voltage source and one or more parameters associated with the second voltage source; and
selectively open and close one of the first switch and the second switch and the fourth switch to cause the terminal coupled to the output of the fourth switch to carry the signal at the second voltage based on one or more parameters associated with the first voltage source and one or more parameters associated with the second voltage source.

13. The controller of claim 12, wherein the one or more parameters of the first voltage source and the one or more parameters of the second voltage source comprise an input voltage, an output voltage, and an output current.

14. The controller of claim 12, wherein the one or more parameters of the first voltage source and the one or more parameters of the second voltage source comprise a voltage source topology and a previous power conversion efficiency.

15. The controller of claim 12, further comprising a table for determining which of the first switch and the second switch to close along with the third switch to cause the terminal coupled to the output of the third switch to carry the signal at the first voltage.

16. The controller of claim 12, wherein the circuitry is configured to selectively close one of the first switch and the second switch and the third switch to cause the terminal coupled to the output of the third switch to carry the signal at the first voltage based on which of the first voltage source and the second voltage source generates a voltage closest to the first voltage.

17. The controller of claim 12, wherein the circuitry is further configured to:
selectively open and close an inductor input switch coupled between the inductor and each of the first switch and the second switch and further coupled to ground, the inductor input switch being configured to conduct current from ground when the power conversion circuit is in a buck configuration; and
selectively open and close an inductor output switch coupled between the inductor and each of the third switch and the fourth switch and further coupled to ground, the inductor input switch being configured to conduct current to ground when the power conversion circuit is in a boost configuration.

18. A controller configured to control a power conversion circuit, the controller comprising:
means for coupling to a first plurality of switches comprising:
a first switch having an input coupled to a first voltage source and an output coupled to an input terminal of an inductor; and
a second switch having an input coupled to a second voltage source and an output coupled to the input terminal of the inductor;
means for coupling to a second plurality of switches comprising:
a third switch having an input coupled to an output terminal of the inductor and an output coupled to a terminal configured to carry a signal at a first voltage; and
a fourth switch having an input coupled to the output terminal of the inductor and an output coupled to a terminal configured to carry a signal at a second voltage;
means for selectively opening and closing one of the first switch and the second switch and the third switch to cause the terminal coupled to the output of the third switch to carry the signal at the first voltage based on one or more parameters associated with the first voltage source and one or more parameters associated with the second voltage source; and
means for selectively opening and closing one of the first switch and the second switch and the fourth switch to cause the terminal coupled to the output of the fourth switch to carry the signal at the second voltage based on one or more parameters associated with the first voltage source and one or more parameters associated with the second voltage source.

19. The controller of claim 18, wherein the one or more parameters of the first voltage source and the one or more parameters of the second voltage source comprise an input voltage, an output voltage, and an output current.

20. The controller of claim 18, wherein the one or more parameters of the first voltage source and the one or more parameters of the second voltage source comprise a voltage source topology and a previous power conversion efficiency.

21. The controller of claim 18, further comprising means for determining, using a table, which of the first switch and the second switch to close along with the third switch to cause the terminal coupled to the output of the third switch to carry the signal at the first voltage.

22. The controller of claim 18, further comprising means for selectively closing one of the first switch and the second switch and the third switch to cause the terminal coupled to the output of the third switch to carry the signal at the first voltage based on which of the first voltage source and the second voltage source generates a voltage closest to the first voltage.

23. A method for controlling a power conversion circuit a first plurality of switches and a second plurality of switches, the first plurality of switches comprising a first switch having an input coupled to a first voltage source and an output coupled to an input terminal of an inductor and a second switch having an input coupled to a second voltage source and an output coupled to the input terminal of the inductor, the second plurality of switches comprising a third switch having an input coupled to an output terminal of the inductor and an output coupled to a terminal configured to carry a signal at a first voltage and a fourth switch having an input coupled to the output terminal of the inductor and an output coupled to a terminal configured to carry a signal at a second voltage, the method comprising:
selectively opening and closing one of the first switch and the second switch and the third switch to cause the terminal coupled to the output of the third switch to carry the signal at the first voltage based on one or more parameters associated with the first voltage source and one or more parameters associated with the second voltage source; and
selectively opening and closing one of the first switch and the second switch and the fourth switch to cause the terminal coupled to the output of the fourth switch to carry the signal at the second voltage based on one or more parameters associated with the first voltage source and one or more parameters associated with the second voltage source.

24. The method of claim 23, wherein the one or more parameters of the first voltage source and the one or more parameters of the second voltage source comprise an input voltage, an output voltage, and an output current.

25. The method of claim 23, wherein the one or more parameters of the first voltage source and the one or more parameters of the second voltage source comprise a voltage source topology and a previous power conversion efficiency.

26. The method of claim 23, further comprising determining, using a table, which of the first switch and the second switch to close along with the third switch to cause the terminal coupled to the output of the third switch to carry the signal at the first voltage.

27. The method of claim 23, further comprising selectively closing one of the first switch and the second switch and the third switch to cause the terminal coupled to the output of the third switch to carry the signal at the first voltage based on which of the first voltage source and the second voltage source generates a voltage closest to the first voltage.

28. The method of claim 23, wherein the first voltage source comprises a battery, and wherein the second voltage source comprises a wireless power receiver.

29. The method of claim 28, wherein the second voltage source comprises at least one of a doubler, full wave bridge, capacitive halver, capacitive doubler, buck converter, boost converter, or buck/boost converter.

30. The method of claim 28, wherein the battery is further coupled to an output of one of the third switch and the fourth switch for charging the battery.
